(19) United States
(12) Patent Application Publication
(10) Pub. No.: US 2013/0319107 A1
(43) Pub. Date: Dec. 5, 2013

(54) FLOW METER HAVING A HOUSING WITH A SEPARABLE CLOSURE

(71) Applicant: KROHNE AG, Basel (CH)

(72) Inventors: Yousif HUSSAIN, Weston Favell (GB); Christopher ROLPH, Hartwell (GB)

(73) Assignee: KROHNE AG, Basel (CH)

(21) Appl. No.: 13/647,012

(22) Filed: Oct. 8, 2012

(30) Foreign Application Priority Data
May 29, 2012 (DE) 10 2012 010 430.8

(51) Int. Cl. G01F 15/14

(52) U.S. Cl. 73/273

(57) ABSTRACT

A flow meter (1) having a housing (2) and at least one measuring tube (3), the housing (2) having an internal volume and at least one pressure compensation opening (4), the internal volume surrounding the measuring tube (3), at least in part, and the pressure compensation opening (4) being closed by a closure arrangement (5) is more simply assembled and requires less maintenance due to a connection being formed between the closure arrangement (5) and the housing (2), the connection being separable by the action of an internal pressure in the internal volume on the closure arrangement (5) when a predetermined internal pressure threshold value is reached so that the closure arrangement (5) is released from the housing (2).

### BACKGROUND OF THE INVENTION

1. Field of the Invention

The invention relates to a flow meter, comprising a housing and at least one measuring tube, the housing having an internal volume and at least one pressure compensation opening, the internal volume surrounding the measuring tube, at least in part, and the pressure compensation opening being connected to a closure means.

2. Description of Related Art

A large number of designs of flow meters are known in the prior art. In particular, in those flow meters in which the measuring tube conveys a fluid under increased pressure, the housing can become ruined in the event of damage, that is to say if the measuring tube becomes damaged, when the internal volume of the housing is filled with the pressurized fluid. Housings of this type are not normally designed to be pressure resistant, since they are merely used to protect the measuring tube and the measuring device against environmental influences. Slight overpressures are compensated, for example, by a gap-like opening in the housing, which forms between individual components of the housing as a result of the internal overpressure. If there are sudden changes in pressure, however, it may be that the housing is damaged considerably, for example, and that housing parts are removed from the housing. Thus. there is a considerable risk of injury to people in the surrounding area.

In order to prevent damage of this type to the housing and to increase safety, housings for flow meters having a pressure compensation opening in order to selectively allow pressure produced in the housing in the event of damage to escape are known in the prior art. For example, German Patent Application DE 10 2006 013 601 discloses a sensor of the vibration type, which has a housing and a measuring tube extending partly within the housing. The housing is fluid-tight and the measuring tube is passed through the respective housing walls on the inlet side and on the outlet side in a tight manner. So as to selectively compensate for undesired overpressures occurring in the housing, the housing has a pressure compensation opening, via which the fluid can escape from the housing. This pressure compensation opening is closed by a bursting disc or by means of a pressure relief valve.

However, the flow meters known from the prior art comprising a housing which has a pressure compensation opening have the disadvantage that the pressure compensation openings are closed by very complex closure means, for example, bursting discs or pressure relief valves, whereby the effort involved in assembly and maintenance of the flow meter is very high.

### SUMMARY OF THE INVENTION

Starting from the aforementioned prior art, the primary object of the present invention is to provide a flow meter comprising a pressure compensation opening, wherein the complexity of assembly and maintenance is reduced.

The above object is achieved initially and basically in a generic flow meter in that a connection is formed between the closure means and the housing, and in that the connection can be separated by the action of an internal pressure in the internal volume on the closure means when a predetermined internal pressure threshold value is reached, such that the closure means is released from the housing. The flow meter is preferably a Coriolis mass flow meter comprising at least one measuring tube, preferably at least two or at least four measuring tubes, which are surrounded in part by the housing. The pressurized fluid is conveyed within the measuring tubes during operation. The housing has a closed internal volume, which surrounds the measuring tubes in part. Normal pressure or, selectively, a slight negative pressure prevails in the internal volume of the housing during operation. The pressure compensation opening connects the internal volume of the housing to the surrounding environment of the flow meter.

In the event of damage that causes fluid to enter the internal volume of the housing from the measuring tubes, an internal pressure is produced in the internal volume of the housing. The housing of the flow meter, in particular of the Coriolis mass flow meter, has a pressure compensation opening to compensate for an internal overpressure, the pressure compensation opening being closed by a closure means. The closure means prevents dirt and/or moisture from the outside from penetrating into the internal volume of the housing of the flow meter.

A connection is formed between the closure means and the housing, in particular, the pressure compensation opening, and can be separated by the action of the internal pressure on the closure means when a specific internal pressure threshold value is reached. Once a predetermined internal pressure threshold value is reached, the connection between the closure means and the housing is consequently separated, whereby the closure means is released from the housing. The closure means is thus arranged on the housing, in particular over the pressure compensation opening, in such a way that the closure means is detached from the housing by the action of the internal pressure in the housing as soon as the internal pressure reaches a predetermined value, and in particular, exceeds a predetermined value.

The closure means is released from the housing in a non-destructive manner by merely separating the connection between the closure means and the housing, in particular, the pressure compensation opening. The closure means itself is not damaged during separation of the connection, and therefore, it is detached from the housing and, in particular, is removed from the housing in one piece. The connection between the closure means and the housing is consequently weaker than the inner cohesion of the closure means itself, and therefore, the connection is always separated before the closure means is destroyed. The pressure compensation opening is advantageously arranged on a surface of the housing directed upwardly in the assembled state so that, for example, in the event of damage, the closure means is removed upwardly. The detachment of the closure means is preferably irreversible, and therefore, once detached, the same closure means cannot close the pressure compensation opening a second time.

The flow meter according to the invention has the advantage that a compact pressure relief system can be provided in a simple manner for a housing under normal pressure during normal operation by detaching a closure means from the housing as a result of the internal pressure and releasing a pressure compensation opening when the internal pressure reaches or exceeds a predetermined internal pressure threshold value. Due to this simple design, the complexity of the assembly and maintenance of the flow meter is reduced. To detach the closure means, in particular to separate the connection between the closure means and the housing, the force resulting from the internal pressure acting over the area of the closure means has to be greater than the retaining force of the connection, and the retaining force of the connection consequently is less than the force resulting from the internal pressure over the area of the closure means. The relevant area of the closure means is always the area of the closure means to which the internal pressure is applied, preferably the area of the pressure compensation opening. At constant internal pressure, the force acting on the closure means is thus greater if the area of the closure means over which the internal pressure may act is greater. Therefore, it is clearly evident that the internal pressure threshold value at which the connection between the closure means and housing is separated is adjusted by fixing or varying the retaining force or strength of the connection between the closure means and the housing and/or the relevant area of the closure means.

The connection between the closure means and the housing has a sufficient retaining force to withstand slight pressure fluctuations, for example, caused by temperature changes, without damage. For example, the closure means is produced from a metal, a rubber, a silicone or a plastic, in particular a polyester or a polycarbonate.

In particular, the flow meter can be produced in a simple manner if, in accordance with a first embodiment, the connection is designed at least in part as an integral joint, and the connection is preferably formed using an adhesive, at least in part, so that the adhesive is destroyed, at least in part, at a predetermined internal pressure threshold value. The closure means is consequently connected in a material integrated manner to the housing, wherein the integral joint is separated by the action of the internal pressure on the closure means when a predetermined internal pressure threshold value is reached, and therefore, the closure means releases from the housing. For example, the closure means is made of a plastic, which is applied to the pressure compensation opening, at least in part, in a paste-like state and is then cured, thus forming a connection with the surface of the housing.

The connection is preferably formed at least in part using an adhesive so that the adhesive is destroyed, at least in part, at a predetermined internal pressure threshold value. The closure means is thus fastened to the housing by the adhesive. A large number of glues, but also soldered or welded connections, are conceivable adhesives, wherein, when an internal pressure exceeding the internal pressure threshold value is present in the housing, merely the connection, that is to say the glue, solder or weld seam, is always damaged or destroyed, and therefore, the closure means always detaches in one piece from the housing of the flow meter, at least in part.

In this exemplary embodiment, the adhesive force (retaining force) of the connection between the closure means and the housing, in particular between the closure means and the adhesive and between the adhesive and the housing, is set in such a way that the adhesive force is slightly below the force resulting at the desired internal pressure threshold value from the respective internal pressure over the area of the closure means.

The setting of the force—consequently of the internal pressure threshold value at which the closure means detaches from the housing—has proven to be advantageous, in accordance with a further embodiment, if the connection is designed at least in part as a non-positive connection, and preferably, if the closure means is arranged at least in part in the pressure compensation opening, more preferably completely in the pressure compensation opening. The connection between the closure means and the housing is designed at least in part as a non-positive connection, which means, for example, that the connection can be produced partly in a non-positive manner and partly by an integral bond. The selection of the means to produce the connection depends on the desired retaining force of the connection and therefore, also on the desired internal pressure threshold value.

With a non-positive connection, the retaining force of the connection is preferably slightly less than the force acting on the closure means as a result of the internal pressure when the internal pressure threshold value is reached. The closure means is preferably arranged at least in part in the pressure compensation opening so that the areas of the pressure compensation opening and of the closure means are frictionally engaged. As soon as the force produced by the internal pressure and acting on the closure means has overcome the static friction between the closure means and the pressure compensation opening, the closure means slides out from the pressure compensation opening, which means separation of the connection between the closure means and the housing or detachment of the closure means from the housing. For example, the closure means thus has an elongate main body, which is arranged at least in part in the pressure compensation opening, wherein, in an end region of the elongate main body, a head region is provided of which the diameter is greater than the diameter of the pressure compensation opening, and therefore the expanded head of the closure means rests on a surface of the housing. In cross section, the closure means is thus T-shaped for example.

The closure means is particularly preferably arranged completely in the pressure compensation opening so that the closure means disappears completely in the pressure compensation opening and is merely pressed out from the pressure compensation opening by the action of the internal pressure on the closure means when the internal pressure threshold value is exceeded, whereby the closure means is released from the housing. For example, the closure means is advantageously produced from a rubber or a silicone, and therefore the closure means is slightly compressed when introduced into the pressure compensation opening, thus producing a radial force, which improves the seal between the closure means and the pressure compensation opening.

In accordance with a further embodiment, to influence the connection, the connection is designed at least in part as a positive connection, the housing preferably has an undercut, and the closure means is retained by the undercut, at least in part. The connection between the closure means and the housing is consequently designed at least in part as a positive connection, and therefore, the closure means is retained so as to seal the pressure compensation opening as long as the positive retaining force of the connection is greater than the force exerted on the closure means as a result of the internal pressure above the internal pressure threshold value. To this end, for example, the closure means is retained on the housing of the flow meter by a clip so as to seal the pressure compensation opening.

Furthermore, the housing preferably has an undercut and the closure means is retained at least in part by the undercut. The housing preferably has an undercut in the region of the pressure compensation opening, the undercut engaging around or over the closure means, at least in part, so that the closure means is deformed in a flexible manner when the internal pressure in the housing reaches the internal pressure threshold value, whereby the closure means escapes from the engagement of the undercut and releases the pressure compensation opening. For example, the undercut is designed integrally with the housing, but alternatively the undercut is also formed as a separate component on the housing.

The connection between the closure means and the housing preferably is formed of a combination of an integral joint and/or non-positive and/or positive connection, wherein the proportions of the types of connection are selected according to the way in which the retaining force of the connection is to be designed, in particular, according to the desired value of the internal pressure threshold value. Any combination between proportions of an integral joint and/or non-positive and/or positive connection is conceivable.

With regard to the arrangement of the closure means, it has been found to be advantageous in accordance with a further embodiment of the flow meter if the closure means is arranged, at least in part, on a surface of the housing. The closure means is preferably arranged completely on a surface. If the internal pressure threshold value is exceeded, the closure means may detach easily from the surface of the housing, thus releasing the pressure compensation opening. The closure means is particularly preferably arranged on an outer surface so that the closure means can be detached easily from the housing of the flow meter as a result of the internal pressure. A bonded connection produced by means of an adhesive and in which merely the adhesive connection between the closure means and the housing is separated when the internal pressure threshold value is exceeded is particularly preferred.

In accordance with a further embodiment, it is preferable if the closure means is arranged on an inner surface of the housing and if the closure means escapes outwardly through the pressure compensation opening in a flexible manner at a predetermined internal pressure threshold value. The closure means is thus arranged on the inner side on an inner surface of the housing so as to seal the pressure compensation opening and is produced from a material which makes it possible for the closure means to detach from the inner surface of the housing when a predetermined internal pressure threshold value is exceeded and to be pressed out from the housing through the pressure compensation opening by the internal pressure. For example, the closure means is thus shaped in such a way that such a pressing out is ensured. For example, such a shape is provided in such a way that the closure means is curved into the pressure compensation opening in the region thereof. The material of the closure means is sufficiently flexible to allow escape through the pressure compensation opening.

In accordance with a further embodiment, accidental detachment of the closure means is prevented by the arrangement of a recess, surrounding the pressure compensation opening, in the housing, and in particular by the arrangement of the closure means at least in part in the recess. The recess is preferably arranged in the outer surface of the housing so as to surround the pressure compensation opening so that the closure means can be arranged in the recess in such a way that the closure means forms a planar surface together with the remaining surface of the housing. For example, the closure means is thus prevented from detaching accidentally by being grasped from beneath.

The recess preferably receives the closure means completely, wherein the inner contour of the recess preferably corresponds to the outer contour of the closure means. It is also advantageous if a head region of the closure means is arranged in the recess for example, while a region of the closure means connecting to the head region projects into the pressure compensation opening so that the closure means forms a type of plug in the pressure compensation opening, wherein manual removal of the closure means by being grasped from beneath is not possible. The closure means is merely pressed out from the pressure compensation opening or detached from the surface of the housing by the internal pressure acting on the closure means through the pressure compensation opening, in particular when an internal pressure threshold value is exceeded, thus releasing the pressure compensation opening.

In accordance with a further embodiment, the area of the pressure compensation opening may vary by providing a plurality of pressure compensation openings. For example, the plurality of pressure compensation openings are arranged directly side by side so that the entire area of the pressure compensation openings corresponds to the active area of the internal pressure on the closure means. For example, two, three or four pressure compensation openings are provided, although the pressure compensation openings are also provided, for example, in such a number that the pressure compensation openings are arranged in a sieve-like manner in a region. Such an arrangement of pressure compensation openings is closed in a planar manner, for example, by a closure means.

In accordance with a further embodiment, the plurality of pressure compensation openings is preferably closed by a single closure means. The closure means thus extends either in a planar manner over the entire plurality of pressure compensation openings, as in the previously described exemplary embodiment with the sieve-like pressure compensation openings, and is connected to the housing in the intermediate regions or merely in the edge regions so that this connection is separated by the pressure acting on the closure means through the pressure compensation openings, in particular by the resultant force. The closure means preferably also has a multiplicity of concave curvatures, which each extend into a pressure compensation opening so that the closure means is introduced at least in part into each of the pressure compensation openings provided.

In accordance with a further embodiment, so as to advantageously design the detachment of the closure means very precisely, the pressure compensation openings are closed by a number of closure means corresponding to the number of pressure compensation openings. A separate closure means is consequently provided for each pressure compensation opening. For example, a separate connection having a different connection force is also provided for each pressure compensation opening, and therefore the different closure means in the different pressure compensation openings are detached at different internal pressure threshold values.

In accordance with a further embodiment, an embodiment of a flow meter comprising a closure means which, in particular, is arranged in a recess can be implemented particularly advantageously by forming the closure means as a substantially planar disk. The extension of the closure means in two directions of a plane arranged orthogonal to one another is consequently greater than the extension of the closure means in the respective third direction arranged orthogonal thereto. The closure means is arranged as a planar disk, for example, in a corresponding recess, in such a way that the closure means forms a planar surface with the surface of the housing. For example, the planar disk is fastened on the surface of the housing by an adhesive, wherein the adhesive is formed in such a way that it detaches from the housing and/or from the closure means when a predetermined internal pressure threshold value is exceeded so that, ultimately, the closure means detaches from the housing and releases the pressure compensation opening. The closure means is always detached in a non-destructive manner, i.e., without destruction of the closure means.

The properties of the detachment of the closure means from the housing can also be set in such a way that the closure means is formed as a substantially curved disk. As a curved disk, the closure means is merely connected to the housing in an annular edge region, and therefore, this region of the connection has to be separated by the internal pressure. A pressure chamber is formed beneath the curvature of the curved disk, the pressure of said chamber corresponding to the internal pressure in the internal volume of the housing. In particular, a direction of movement of the closure means during detachment from the housing can also be defined by the form of the closure means as a substantially curved disk. Such a design is advantageously suitable with arrangement of the closure means on an inner surface of the housing, since the curvature can be used to control the exit of the closure means through the pressure compensation opening when the internal pressure threshold value is exceeded.

The closure means may advantageously be arranged, at least in part, inside the pressure compensation opening, if, in accordance with a further embodiment, the closure means is formed as a substantially elongate plug. This form of the closure means is a particularly suitable form for arrangement of the closure means in the pressure compensation opening. The closure means is pressed out from the pressure compensation opening when the internal pressure threshold value is exceeded, and otherwise forms a planar surface together with the outer surface of the housing, and in particular with the inner surface of the housing as well. To this end, the closure means is designed in such a way, for example, that the length thereof corresponds to the thickness of the housing wall, and therefore, the closure means completely fills the pressure compensation opening in the wall of the housing.

In accordance with a further embodiment, the pressure compensation opening can be easily produced in a wall of the housing of the flow meter if the pressure compensation opening has a circular, oval or polygonal cross section, in particular, a square cross section. The abovementioned cross sections are produced and can be formed in the wall of the housing in a simple manner using the conventional production methods. Furthermore, these shapes of pressure compensation openings have also proven to be particularly advantageous in terms of flow, for example, so as to reduce the level of noise when pressure compensation is being carried out.

More specifically, there are a large number of possibilities for designing and developing the flow meter according to the invention. To this end, reference is made the detailed description of preferred exemplary embodiments in conjunction with the accompanying drawings.

### BRIEF DESCRIPTION OF THE DRAWINGS

FIG. 1 is a side view of an exemplary embodiment of a flow meter,

FIGS. 2a- 2i show exemplary embodiments of closure means,

FIGS. 3a & 3b show further exemplary embodiments of closure means,

FIGS. 4a & 4b show exemplary embodiments of pressure compensation openings as enlarged details of the encircled portion of FIG. 1,

FIGS. 5a & 5b show further exemplary embodiments of pressure compensation openings as enlarged details of the encircled portion of FIG. 1, and

FIGS. 6a-6c show still other exemplary embodiments of closure means as enlarged details of the encircled portion of FIG. 1.

### DETAILED DESCRIPTION OF THE INVENTION

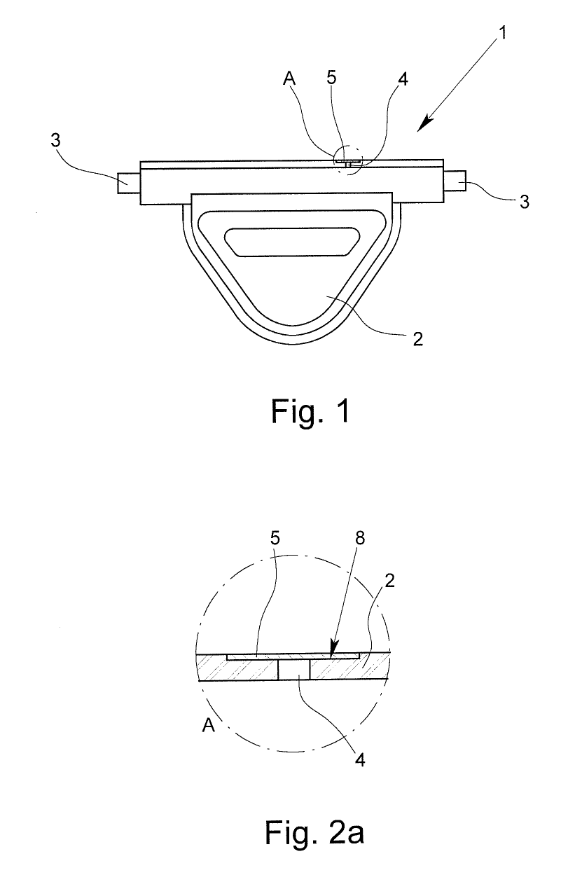

FIG. 1 shows a side view of an exemplary embodiment of a flow meter 1. The flow meter 1 comprises a housing 2 and two measuring tubes 3 and is designed as a Coriolis mass flow meter. The measuring tubes 3 are curved in a V-shaped manner in this exemplary embodiment and are arranged parallel to one another. A pressure compensation opening 4 passes completely through the wall of the housing 2 as far as the inner chamber of the housing 2 so as to connect the internal volume of the housing 2 to the environment surrounding the flow meter 1, and is arranged in the upper region of the housing 2 as illustrated in FIG. 1. The pressure compensation opening 4 is closed by a closure means 5. A connection is formed between the closure means 5 and the housing 2, wherein the connection is separated by the action of the internal pressure on the closure means 5 when a predetermined internal pressure threshold value is reached, thus detaching the closure means 5 from the housing 2.

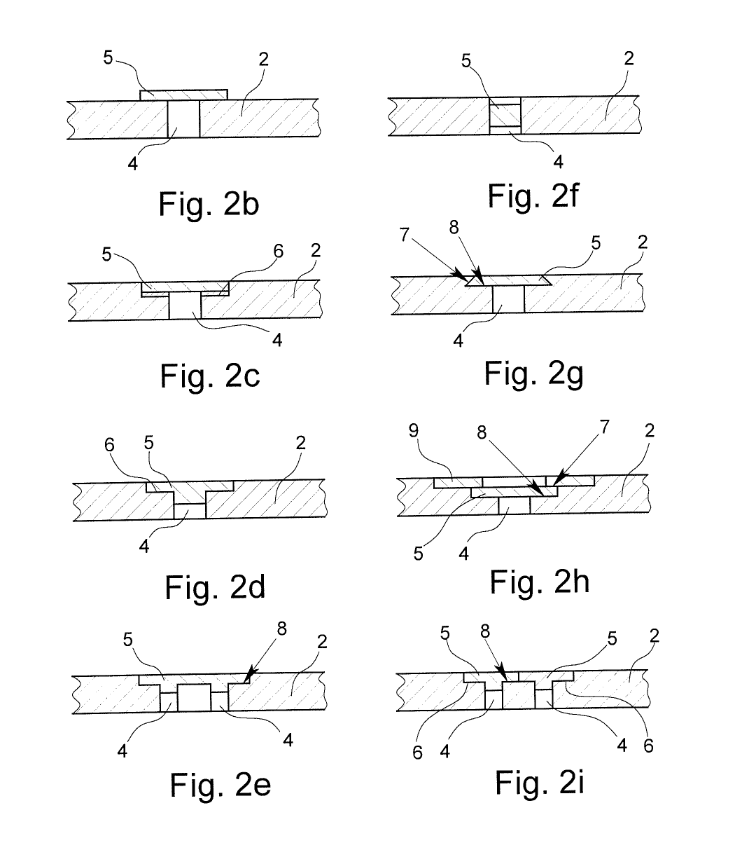

FIG. 2a shows an enlarged view of the pressure compensation opening 4 in accordance with detail A in FIG. 1. The pressure compensation opening 4 passes through the wall of the housing 2 completely. A connection (in this case, an adhesive connection) is formed between the housing 2 and the closure means 5 that is designed to separate if the internal pressure in the internal volume of the housing exceeds a predetermined internal pressure threshold value.

FIGS. 2b to 2i show exemplary embodiments of closure means, which are arranged on a housing 2 of a flow meter 1. According to FIG. 2b, the closure means 5 is formed as a planar disk and is arranged on the outer surface of the housing 2 so as to seal the pressure compensation opening 4. As soon as the pressure in the internal volume of the housing 2, and therefore, also the pressure in the pressure compensation opening 4, exceeds a predetermined internal pressure threshold value, the closure means 5 detaches from the housing, separating the connection between the closure means 5 and the housing 2.

FIG. 2c shows an exemplary embodiment of a closure means 5, which is likewise formed as a substantially planar disk and is fastened to the housing 2 by an adhesive 6. In this case, the adhesive 6 forms the connection between the closure means 5 and the housing 2, wherein the adhesive 6 is formed in such a way that it is destroyed when the internal pressure threshold value is reached. The adhesive 6 is illustrated particularly clearly in this exemplary embodiment compared to the other figures.

FIG. 2g shows an exemplary embodiment of a closure means 5, which is arranged in an undercut 7 formed in the housing 2 and is retained with a positive fit by this undercut 7. As soon as the internal pressure in the internal volume of the housing 2 exceeds a predetermined internal pressure threshold value, the closure means 5 deforms in such a flexible manner that it escapes from the positive retention of the undercut 7, detaches from the housing 2, and thus, releases the pressure compensation opening 4. The closure means 5 according to the exemplary embodiments in FIGS. 2c, 2d, 2e, 2g and 2i are arranged in a recess 8 in the housing 2 in such a way that the closure means 5 forms a planar surface together with the surface of the housing 2.

FIG. 2d shows an exemplary embodiment of a closure means 5 having a T-shaped cross section with a top which likewise forms a planar surface together with the outer surface of the housing 2 since it is located in recess 8, and the closure means 5 has a base leg arranged in the pressure compensation opening 4 so that, in this exemplary embodiment, a positive connection is produced, at least in part, between the closure means 5 and the housing 2, in particular, the pressure compensation opening 4. A thin layer of an adhesive 6 is applied between the head region of the closure means 5 and the recess 8 in the housing 2 and constitutes an additional bonded part of the connection.

FIG. 2e shows an exemplary embodiment of a single closure means 5, which simultaneously closes two pressure compensation openings 4. The pressure compensation openings 4 are arranged side by side, wherein the closure means 5 is introduced, in part, into each of the pressure compensation openings 4.

FIG. 2f shows an exemplary embodiment of a closure means 5, which is completely introduced into the pressure compensation opening 4. The connection between the closure means 5 and the pressure compensation opening 4 is exclusively non-positive in this exemplary embodiment, and therefore, the closure means 5 is pressed out from the pressure compensation opening 4 as soon as the internal pressure threshold value, which acts over the area of the closure means 5, exceeds the static friction between the closure means 5 and the pressure compensation opening 4, in particular, the housing 2. The surfaces are adapted in such a way and the materials are selected in such a way that detachment occurs at a desired internal pressure threshold value. In this case, the closure means 5 is formed as a substantially elongate plug.

FIG. 2h shows a further exemplary embodiment of a closure means 5, which is retained with a positive fit by an undercut 7 in the housing. In this exemplary embodiment, the undercut 7 is not formed in one piece with the housing, as in the exemplary embodiment according to FIG. 2g, but is formed by a ring 9 fastened to the housing 2, the ring 9 retaining the closure means 5 with a positive fit. If the internal pressure threshold value is exceeded, the closure means 5 deforms plastically and is released from the positive connection with the undercut 7, thus releasing the pressure compensation opening 4.

FIG. 2i shows an exemplary embodiment in which a number of closure means 5 corresponding to the number of pressure compensation openings 4 is provided, the closure means closing the pressure compensation openings 4. The closure means 5 are identical and the connections between the closure means 5 and the housing 2 are likewise identical, and thus, have an identical retaining force. In this exemplary embodiment, the connection also has a bonded component (provided by the adhesive layer 6) and a non-positive component (provided by the partial introduction into the pressure compensation opening 4).

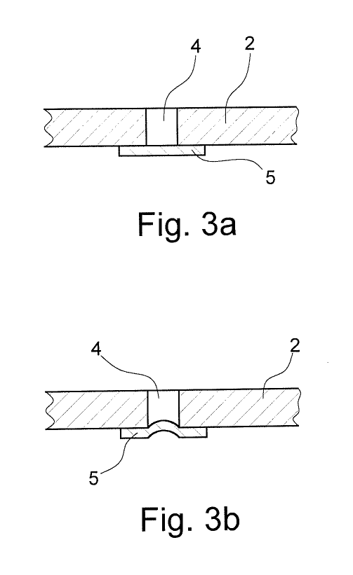

FIG. 3a shows an exemplary embodiment with a closure means 5, which is arranged on an inner surface of the housing 2. At a predetermined internal pressure threshold value within the internal volume of the housing 2, the closure means 5 deforms plastically, and therefore lifts off from the inner surface of the housing 2 and is pressed outwardly through the pressure compensation opening 4. This embodiment has the advantage that accidental detachment of the closure means 5 is prevented.

FIG. 3b shows a further exemplary embodiment, in which closure means 5 is arranged on the inner surface in the internal volume of the housing 2. The closure means 5 is formed as a substantially curved disk, wherein the curvature of the closure means 5 projects into the pressure compensation opening 4 so that, when the internal pressure threshold value is exceeded, the plastic deformation of the closure means 5 is directed by the curvature, wherein the closure means 5 is then pressed out from the pressure compensation opening 4 by the internal pressure.

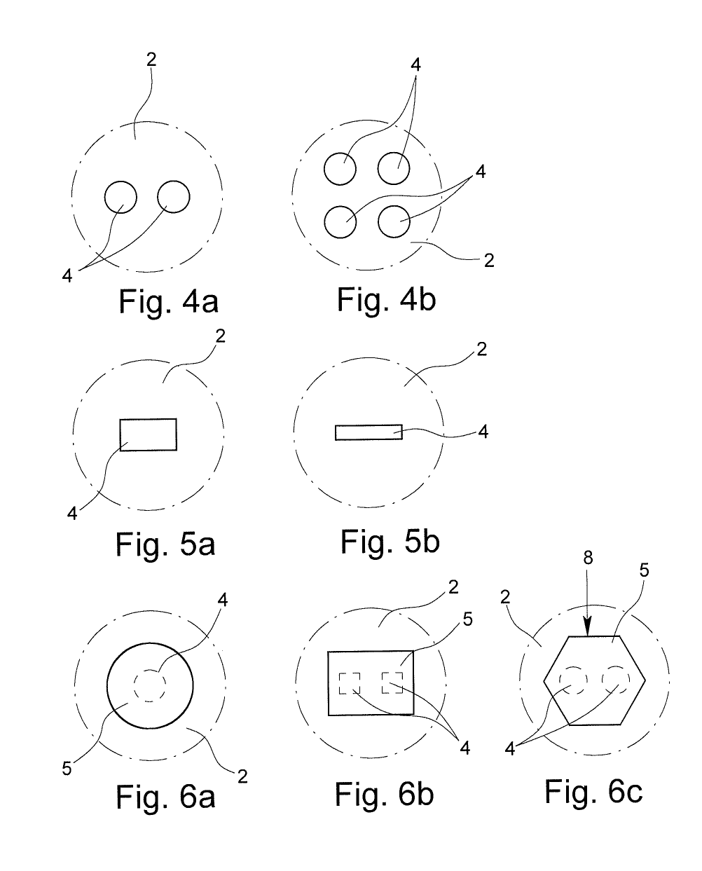

FIG. 4a shows an exemplary embodiment with a plurality of pressure compensation openings 4 in a housing 2 as an enlarged detail of the encircled portion of FIG. 1. The two pressure compensation openings 4 are circular and are side by side in the housing 2. FIG. 4b shows an exemplary embodiment with four circular pressure compensation openings 4 arranged side by side in housing 2.

FIG. 5a shows an exemplary embodiment of a rectangular pressure compensation opening 4 in housing 2. FIG. 5b shows a further exemplary embodiment of a rectangular pressure compensation opening 4 in housing 2, wherein the pressure compensation opening 4 in FIG. 5b is narrower as compared to the pressure compensation opening 4 in FIG. 5a.

FIG. 6a shows an exemplary embodiment of a closure means 5 which is formed as a circular disk and is arranged on the housing 2 so as to seal the pressure compensation opening 4 and is connected to the housing 2. Both the pressure compensation openings 4 and the closure means 5 are circular in cross section.

FIG. 6b shows an exemplary embodiment of a closure means 5 which has a substantially rectangular cross section and closes two square pressure compensation openings 4 in the housing 2.

FIG. 6c shows an exemplary embodiment of a closure means 5 which is hexagonal in cross section, wherein the closure means 5 closes two circular pressure compensation openings 4 arranged side by side. The pressure compensation openings 4 are arranged side by side and are closed by the single closure means 5. The closure means 5 is arranged in a recess 8 in the housing 2.

What is claimed is:

1. Flow meter, comprising:
at least one measuring tube,
a housing, the housing having an internal volume and at least one pressure compensation opening, the internal volume surrounding the at least one measuring tube, at least in part, and
closure means closing the at least one pressure compensation opening,
wherein a connection is formed between the closure means and the housing that is separable by action of an internal pressure in the internal volume on the closure means when a predetermined internal pressure threshold value is reached so that the closure means is removed from the housing.

2. Flow meter according to claim 1, wherein the connection is foamed at least in part as an integral joint.

3. Flow meter according to claim 1, wherein the connection is formed at least in part by an adhesive that is adapted to be at least partially destroyed at a predetermined internal pressure threshold value.

4. Flow meter according to claim 1, wherein the connection is formed at least in part as a non-positive connection, and the closure means is arranged at least in part in the pressure compensation opening

5. Flow meter according to claim 4, wherein the closure means is arranged completely in the pressure compensation opening.

6. Flow meter according to claim 1, wherein the connection is formed at least in part as a positive connection.

7. Flow meter according to claim 6, wherein the positive connection comprises an undercut foamed in the housing, and wherein the closure means is retained at least in part by the undercut.

8. Flow meter according to claim 1, wherein the closure means is arranged on a surface of the housing.

9. Flow meter according to claims 1, wherein the closure means is arranged on an inner surface of the housing, and wherein the closure means is adapted to escape outwardly through the pressure compensation opening in a flexible manner at a predetermined internal pressure threshold value.

10. Flow meter according to claims 1, wherein a recess is arranged in the housing surrounding the pressure compensation opening, and the closure means is arranged at least in part in the recess.

11. Flow meter according to claim 1, wherein said at least one pressure compensation opening comprises a plurality of pressure compensation openings.

12. Flow meter according to claim 11, wherein the plurality of pressure compensation openings is closed by a single closure means.

13. Flow meter according to claim 8, wherein the pressure compensation openings are closed by a number of closure means corresponding to the number of pressure compensation openings.

14. Flow meter according to claim 1, wherein the closure means is formed as a substantially planar disk.

15. Flow meter according to claim 1, wherein the closure means is formed as a substantially curved disk.

16. Flow meter according to claim 1, wherein the closure means is formed as a substantially elongate plug.

17. Flow meter according to claim 1, wherein the pressure compensation opening has one of a circular, oval and polygonal cross section.

18. Flow meter according to claim 1, wherein the pressure compensation opening has a rectangular cross section.

19. Flow meter according to claim 10, wherein the closure means has a T-shaped cross section with a disc shaped top which is located in said recess and a base leg that is located in the pressure compensation opening.
